(19) United States
(12) Patent Application Publication
(10) Pub. No.: US 2022/0403772 A1
(43) Pub. Date: Dec. 22, 2022

(54) ACTUATOR

(71) Applicant: DENSO CORPORATION, Kariya-city (JP)

(72) Inventors: Tomoyuki ISHIDUKA, Kariya-city (JP); Tetsuji YAMANAKA, Kariya-city (JP); Masashi YAMAGUCHI, Kariya-city (JP); Naoaki KOUNO, Kariya-city (JP)

(21) Appl. No.: 17/893,751

(22) Filed: Aug. 23, 2022

Related U.S. Application Data
(63) Continuation of application No. PCT/JP2021/005692, filed on Feb. 16, 2021.

(30) Foreign Application Priority Data
Feb. 24, 2020 (JP) 2020-028912

(51) Int. Cl. F02B 37/18; F16K 31/04; F16K 31/53; F16H 57/029; F16H 57/04

(52) U.S. Cl. CPC F02B 37/186; F16K 31/047; F16K 31/53; F16H 57/029; F16H 57/0464; F16H 2057/02034

(57) ABSTRACT

An actuator includes an electric motor, an output shaft and a speed reducer. The speed reducer includes at least one metal gear which has a plurality of teeth made of metal. The speed reducer is configured to transmit rotation, which is outputted from the electric motor, to the output shaft after reducing a rotational speed of the rotation. The actuator includes a housing that receives the electric motor and the speed reducer. The actuator includes a plate member that is configured to limit scattering of a scattering object, which is generated in response to an operation of the speed reducer and is scattered from the at least one metal gear.

### CROSS REFERENCE TO RELATED APPLICATIONS

This application is a continuation application of International Patent Application No. PCT/JP2021/005692 filed on Feb. 16, 2021, which designated the U.S. and claims the benefit of priority from Japanese Patent Application No. 2020-028912 filed on Feb. 24, 2020. The entire disclosures of all of the above applications are incorporated herein by reference.

### TECHNICAL FIELD

The present disclosure relates to an actuator.

### BACKGROUND

Previously, there has been proposed an actuator for a brake device. The actuator includes a compound gear as a component of a speed reducer, and the compound gear has a large diameter gear made of resin and a small diameter gear made of metal which are joined together to rotate integrally.

### SUMMARY

This section provides a general summary of the disclosure, and is not a comprehensive disclosure of its full scope or all of its features.

According to the present disclosure, there is provided an actuator including:

an electric motor;

an output shaft;

a speed reducer that is configured to transmit rotation, which is outputted from the electric motor, to the output shaft after reducing a rotational speed of the rotation; and

a housing that receives the electric motor and the speed reducer.

In the actuator described above, the speed reducer may include at least one metal gear which has a plurality of teeth made of metal. The actuator may further include a plate member that is configured to limit scattering of a scattering object, which is generated in response to an operation of the speed reducer and is scattered from the at least one metal gear, from one space of an internal space of the housing, in which the at least one metal gear is located, to another space of the internal space of the housing, which is other than the one space.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic view indicating an intake/exhaust system of an engine, to which an actuator of an embodiment is applied.

FIG. 2 is an explanatory diagram for explaining a supercharger.

FIG. 3 is a schematic perspective view of the actuator of the embodiment.

FIG. 4 is a schematic top view of the actuator of the embodiment.

FIG. 5 is a schematic top view showing a state where a housing case of the actuator of the embodiment is removed.

FIG. 6 is a schematic top view showing a state where the housing case and an intermediate plate of the actuator of the embodiment are removed.

FIG. 7 is a cross-sectional view taken along line VII-VII in FIG. 4.

FIG. 8 is a cross-sectional view taken along line VIII-VIII in FIG. 4.

FIG. 9 is a cross-sectional view taken along line IX-IX in FIG. 4.

FIG. 10 is an enlarged view of a portion X in FIG. 9.

FIG. 11 is an explanatory diagram for explaining the application amount of grease applied to each meshing portion of a speed reducer.

FIG. 12 is a partial enlarged view of the actuator shown in FIG. 9.

FIG. 13 is a schematic plan view of the intermediate plate.

FIG. 14 is a cross-sectional view taken along line XIV-XIV in FIG. 13.

FIG. 15 is a cross-sectional view taken along line XV-XV in FIG. 13.

FIG. 16 is a cross-sectional view taken along line XVI-XVI in FIG. 13.

FIG. 17 is an explanatory diagram for explaining an assembling order of components at the actuator.

FIG. 18 is a schematic cross-sectional view showing a portion of a cross-section of an intermediate plate in a first modification.

FIG. 19 is a schematic cross-sectional view showing a portion of a cross-section of an intermediate plate in a second modification.

FIG. 20 is a schematic cross-sectional view showing a portion of a cross-section of an intermediate plate in a third modification.

### DETAILED DESCRIPTION

Previously, there has been proposed an actuator for a brake device. The actuator includes a compound gear as a component of a speed reducer, and the compound gear has a large diameter gear made of resin and a small diameter gear made of metal which are joined together to rotate integrally.

In the actuator, when the speed reducer is operated, wear particles of a gear having teeth made of metal and grease applied to the gear may possibly be scattered from one space, in which the gear is located, to another space that is other than the one space. For example, when the grease of the gear made of the metal adheres to a gear made of resin, wear particles of the resin generated at the time of applying a high stress to the gear made of the resin are held by the grease, and thereby the wearing of the gear made of the resin may possibly be promoted. Furthermore, for example, when the wear particles of the gear made of the metal adhere to a magnetic circuit of a rotational angle sensor, an output of the rotational angle sensor may possibly be changed. The above findings are made of the inventors of the present application through diligent study of the inventors of the present application.

According to one aspect of the present disclosure, there is provided an actuator including:

an electric motor;

an output shaft;

a speed reducer that includes at least one metal gear which has a plurality of teeth made of metal, wherein the speed reducer is configured to transmit rotation, which is outputted from the electric motor, to the output shaft after reducing a rotational speed of the rotation;

a housing that receives the electric motor and the speed reducer; and

a plate member that is configured to limit scattering of a scattering object, which is generated in response to an operation of the speed reducer and is scattered from the at least one metal gear, from one space of an internal space of the housing, in which the at least one metal gear is located, to another space of the internal space of the housing, which is other than the one space.

With this structure, the plate member limits the scattering of the scattering object from the metal gear to the other space, so that it is possible to limit the disadvantage caused by the scattering of the scattering object from the metal gear to the predetermined space.

According to another aspect of the present disclosure, there is provided an actuator including:

an electric motor;

an output shaft;

a speed reducer that is configured to transmit rotation, which is outputted from the electric motor, to the output shaft after reducing a rotational speed of the rotation; and

a housing that receives the electric motor and the speed reducer, wherein:

the speed reducer includes:
a pair of metal gears, each of which has a plurality of teeth made of metal, wherein the pair of metal gears are meshed with each other;
a resin gear that has a plurality of teeth made of resin; and
a mating gear that is meshed with the plurality of teeth of the resin gear;

grease, which is lubricant, is applied more to a metal meshing portion, at which the pair of metal gears are meshed with each other, than a resin meshing portion, at which the resin gear and the mating gear are meshed with each other; and

the internal space of the housing is partitioned by a plate member into one space, in which the pair of metal gears are located, and another space, in which the resin gear and the mating gear are located.

When the grease is applied more to the metal meshing portion than the resin meshing portion, the wearing of the metal meshing portion can be sufficiently reduced. In addition, at the time of operating the speed reducer, the plate member limits scattering of the grease, which is applied to the pair of metal gears, to the other space in which the resin gear and the mating gear are located in the internal space of the housing. Therefore, since the wear particles of the resin are less likely to be held by the grease, it is possible to limit the wearing of the resin meshing portion. Specifically, it is possible to limit the disadvantage caused by the scattering of the scattering object (i.e., the grease) from the metal gear to the space, in which the resin gears are located.

According to a further aspect of the present disclosure, there is also provided an actuator including:

an electric motor;

an output shaft;

a speed reducer that includes at least one metal gear which has a plurality of teeth made of metal, wherein the speed reducer is configured to transmit rotation, which is outputted from the electric motor, to the output shaft after reducing a rotational speed of the rotation;

a rotational angle sensor that includes a magnetic circuit device and a sensing device and is configured to sense a rotational angle of the output shaft; and

a housing that receives the electric motor, the speed reducer and the rotational angle sensor, wherein:

an internal space of the housing is partitioned by a plate member into one space, in which the at least one metal gear is located, and another space, in which the magnetic circuit device and the sensing device are located.

With this structure, the plate member limits the scattering of the wear particles, which are generated from the metal gear at the time of operating the speed reducer, to the other space, in which the magnetic circuit device and the sensing device are located in the internal space of the housing. Therefore, the wear particles, which are generated at the metal gear, are less likely to adhere to the magnetic circuit device and the sensing device, so that it is possible to limit an unintended change in the output of the rotational angle sensor. Specifically, it is possible to limit the disadvantage caused by the scattering of the scattering object (i.e., the metal particles) from the metal gear to the space, in which the magnetic circuit device and the sensing device are located.

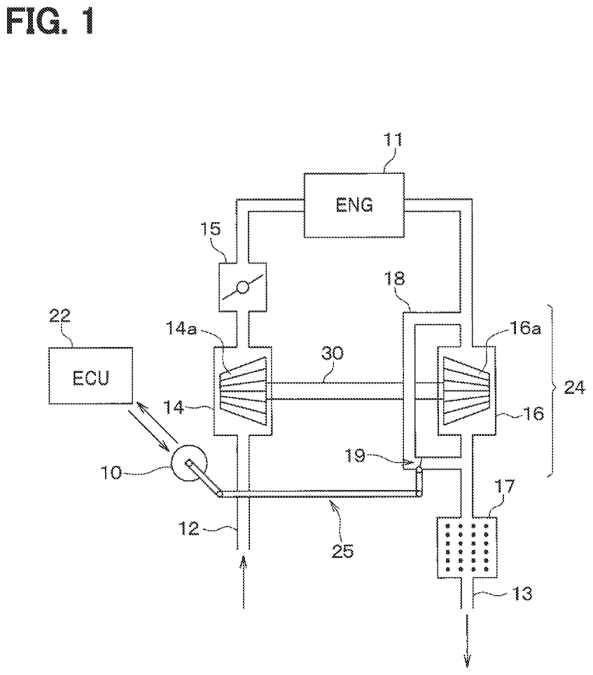

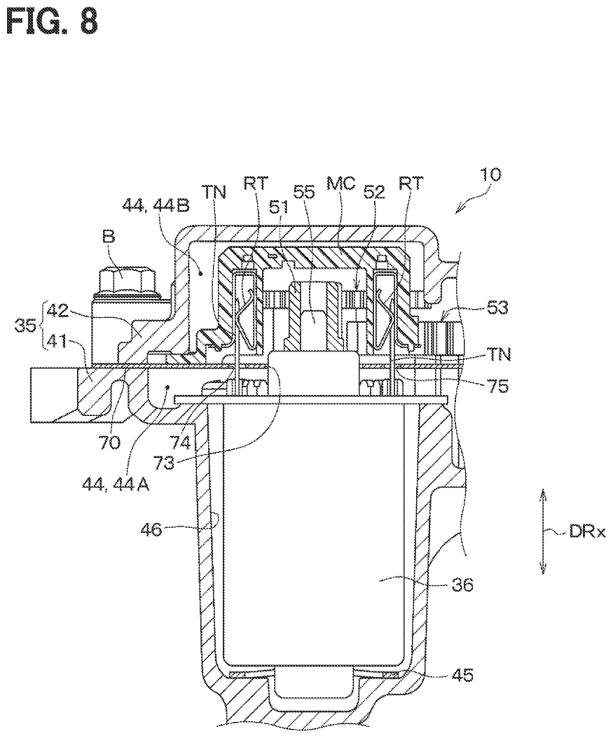

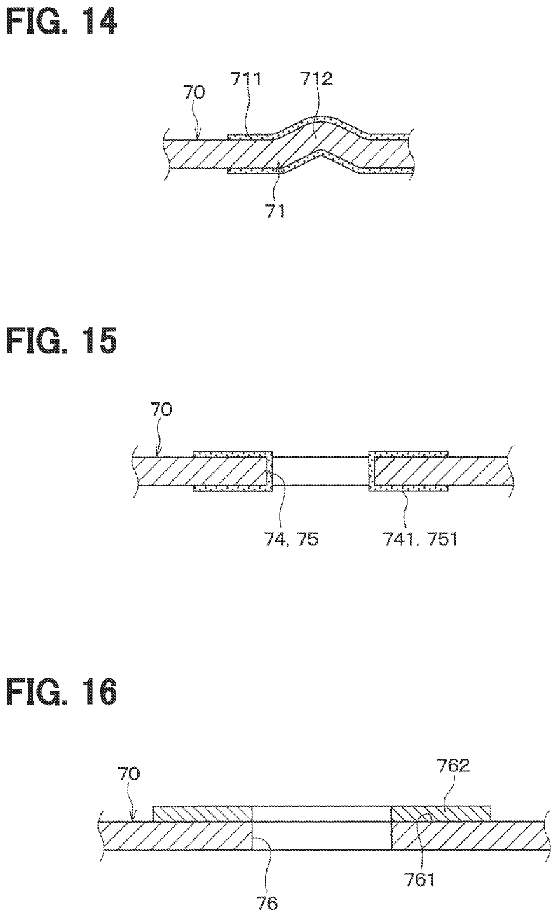

Hereinafter, an embodiment of the present disclosure will be described with reference to FIGS. 1 to 17. In the present embodiment, there will be described an example where an actuator 10 of the present disclosure is applied as a drive device that is configured to drive a boost pressure control valve of a supercharger 24. The supercharger 24 forms a portion of an intake/exhaust system of an internal combustion engine 11 that is a drive source for driving a vehicle.

### (Intake/Exhaust System of Engine 11)

As shown in FIG. 1, the intake/exhaust system of the engine 11 includes: an intake air passage 12, which guides intake air to cylinders of the engine 11; and an exhaust passage 13, which discharges exhaust gas generated in the cylinders to the atmosphere. A compressor wheel 14a of an intake compressor 14 of the supercharger 24 and a throttle valve 15 are installed in the middle of the intake air passage 12. The compressor wheel 14a supercharges the intake air to the engine 11. The throttle valve 15 adjusts the amount of intake air supplied to the engine 11 according to the amount of depression of an accelerator pedal of the vehicle (not shown).

A turbine wheel 16a of an exhaust turbine 16 of the supercharger 24 and a catalyst 17 are installed in the middle of the exhaust passage 13 while the catalyst 17 is configured to purify the exhaust gas. The turbine wheel 16a is connected to the compressor wheel 14a through a rotatable shaft 30. Thus, when the turbine wheel 16a is rotated by exhaust gas energy of the engine 11, the compressor wheel 14a is rotated. The catalyst 17 is a three-way catalyst having a monolithic structure. When the temperature of the catalyst 17 is increased to an activation temperature by the exhaust gas, the catalyst 17 purifies the harmful substances contained in the exhaust gas through an oxidizing action and an reducing action.

A bypass passage 18, which conducts the exhaust gas while bypassing the turbine wheel 16a, is placed in parallel with the turbine wheel 16a in the exhaust passage 13. A wastegate valve 19, which is a boost pressure control valve, is installed in the bypass passage 18. When the wastegate valve 19 is opened, a portion of the exhaust gas from the engine 11 is directly guided to the catalyst 17 through the bypass passage 18. The wastegate valve 19 is opened when the pressure of the exhaust gas from the engine 11 is increased beyond a valve opening pressure of the wastegate valve 19. Furthermore, opening and closing of the wastegate valve 19 is also controlled by an ECU 22.

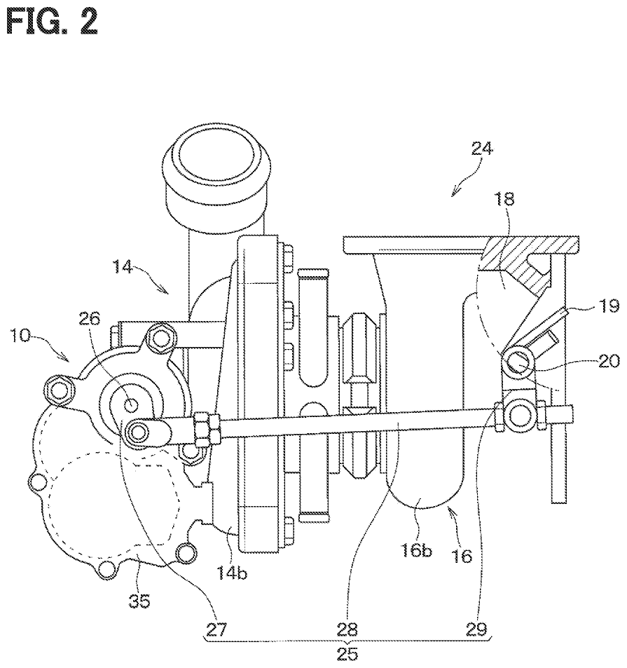

As shown in FIG. 2, the supercharger 24 includes the exhaust turbine 16, the intake compressor 14 and the actuator 10. The exhaust turbine 16 includes the turbine wheel 16a and a turbine housing 16b. The turbine wheel 16a is rotated by the exhaust gas discharged from the engine 11. The turbine housing 16b is shaped in a spiral form and receives the turbine wheel 16a. The intake compressor 14 includes the compressor wheel 14a and a compressor housing 14b. The compressor wheel 14a is rotated when the rotational force of the turbine wheel 16a is transmitted to the compressor wheel 14a. The compressor housing 14b is shaped in a spiral form and receives the compressor wheel 14a.

Besides the turbine wheel 16a, the bypass passage 18 is formed at the turbine housing 16b. The bypass passage 18 directly guides the exhaust gas, which has flowed into the turbine housing 16b, to an exhaust gas outlet of the turbine housing 16b without supplying it to the turbine wheel 16a. The bypass passage 18 is opened and closed by the wastegate valve 19. The wastegate valve 19 is a swing valve that is rotatably supported by a valve shaft 20 at an inside of the turbine housing 16b. The wastegate valve 19 is opened when the pressure of the exhaust gas is increased beyond a valve opening pressure of the wastegate valve 19. Furthermore, opening and closing of the wastegate valve 19 is also controlled by the actuator 10.

The housing 35, which receives the actuator 10, is installed to the intake compressor 14 of the supercharger 24, which is remote from the exhaust turbine 16, in order to avoid the influence of heat of the exhaust gas. The supercharger 24 includes a link mechanism 25 that transmits an output of the actuator 10 to the wastegate valve 19. In the present embodiment, a four-bar linkage mechanism, which includes an actuator lever 27, a rod 28 and a valve lever 29, is used as the link mechanism 25. The actuator lever 27 is connected to an output shaft 26 of the actuator 10 and is rotated by the actuator 10. The valve lever 29 is coupled to the valve shaft 20. The rod 28 transmits a rotational torque, which is applied to the actuator lever 27, to the valve lever 29. The ECU 22, which includes a microcomputer, controls an operation of the actuator 10.

The ECU 22 is an engine control unit. The ECU 22 includes the computer, which has a processor and a memory, and a peripheral circuit thereof. The ECU 22 drives the actuator 10 to open and close the wastegate valve 19 through the link mechanism 25 installed between the actuator 10 and the wastegate valve 19.

Specifically, the ECU 22 controls the actuator 10 to adjust an opening degree of the wastegate valve 19 at, for example, the time of rotating the engine 11 at a high rotational speed to control the boost pressure of the supercharger 24. Furthermore, when the temperature of the catalyst 17 does not reach the activation temperature, for example, immediately after a cold start of the engine, the ECU 22 controls the actuator 10 to fully open the wastegate valve 19 and thereby to warm up the catalyst 17. Thus, the high-temperature exhaust gas, from which the heat is not taken to the turbine wheel 16a, can be directly guided to the catalyst 17 to warm up the catalyst 17 in a short time.

### (Structure of Actuator 10)

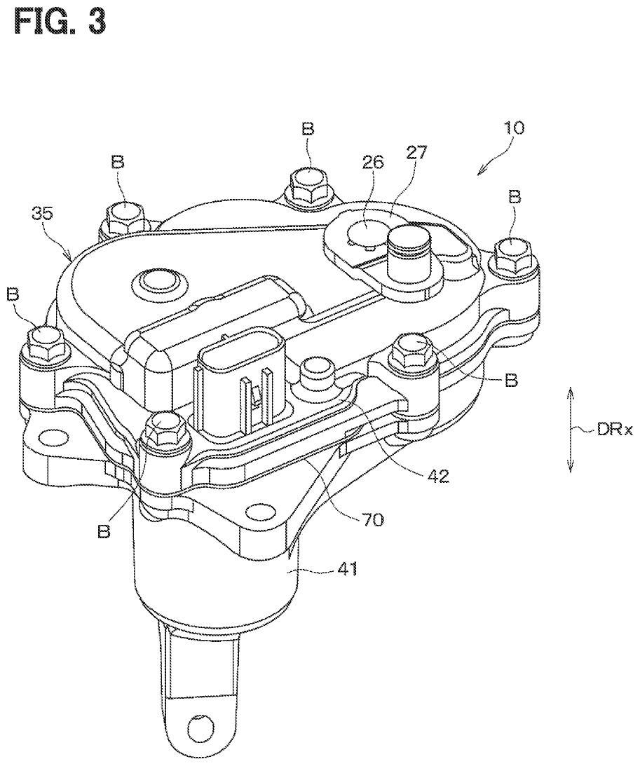

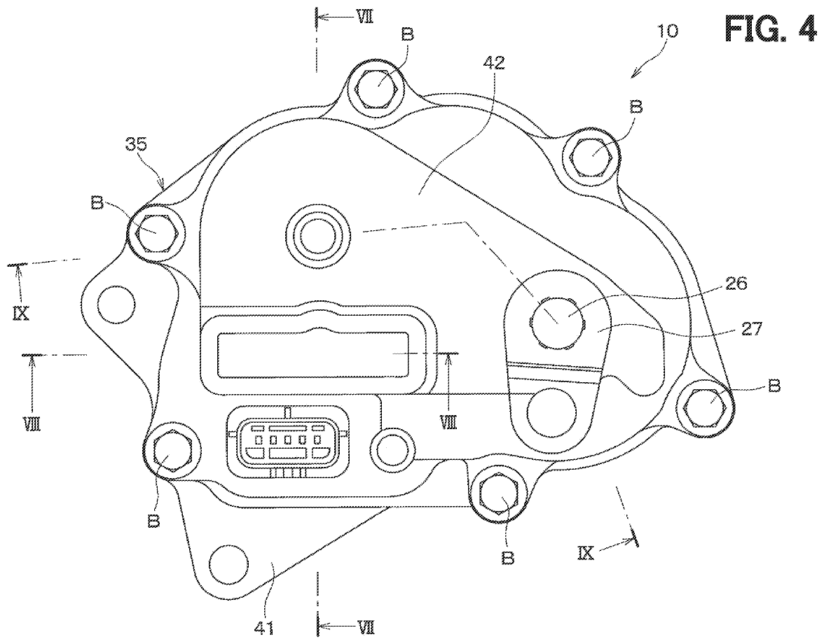

Next, the structure of the actuator 10 will be described with reference to FIGS. 3 to 9. A housing 35, which forms an outer shell of the actuator 10, is installed to the intake compressor 14. As shown in FIGS. 3 and 4, the housing 35 includes a housing main body (serving as a second housing portion) 41 and a housing case (serving as a first housing portion) 42.

The housing main body 41 and the housing case 42 are made of a metal material, such as aluminum, an aluminum alloy or steel. The housing main body 41 and the housing case 42 may be made of resin. Furthermore, the housing main body 41 and the housing case 42 may be formed by any of die casting, gravity casting, injection molding, and pressing. The housing case 42 is fixed to the housing main body 41 by fastening members B. The output shaft 26 projects from the housing case 42 and is coupled to the actuator lever 27. The output shaft 26 is rotatably supported by the housing main body 41.

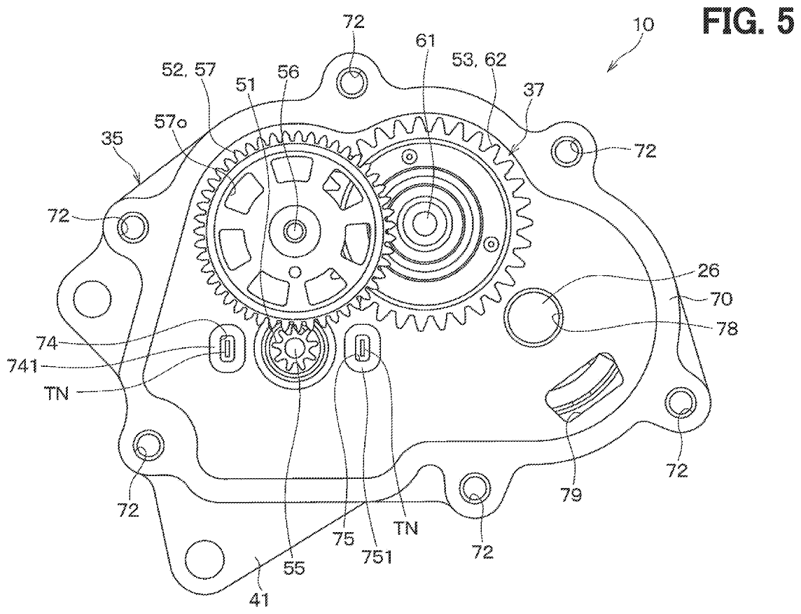

As shown in FIGS. 3 and 5, an intermediate plate 70 is interposed between the housing main body 41 and the housing case 42. The intermediate plate 70 partitions an internal space 44 of the housing 35 into a main-body side space 44A, which is located at the housing main body 41 side, and a case side space 44B, which is located at the housing case 42 side. Details of the intermediate plate 70 will be described later.

As shown in FIGS. 6, 7, 8 and 9, the housing main body 41 cooperates with the housing case 42 to form the internal space 44 of the housing 35. The electric motor 36 is received in the internal space 44. Specifically, most of the electric motor 36 is received in the main-body side space 44A of the internal space 44, which is located at the housing main body 41 side.

The electric motor 36 is inserted into a motor insertion hole 46 of the housing main body 41 and is fixed to the housing main body 41 by screws 47. A wave washer 45 is installed to a bottom surface of the motor insertion hole 46. Here, it should be noted that the wave washer 45 may be eliminated. The electric motor 36 is, for example, a direct current motor, a stepping motor, or the like.

In the electric motor 36, a motor shaft 55 and a pair of terminals TN project from the housing main body 41 side toward the housing case 42. The pair of terminals TN extend in both the main-body side space 44A and the case side space 44B.

The pair of terminals TN are terminals for supplying an electric power to internal devices of the electric motor 36. The pair of terminals TN are connected to a power supply device (not shown) through relay terminals RT, respectively. The relay terminals RT are installed to a motor cover MC which is made of resin and is installed at the inside of the housing case 42.

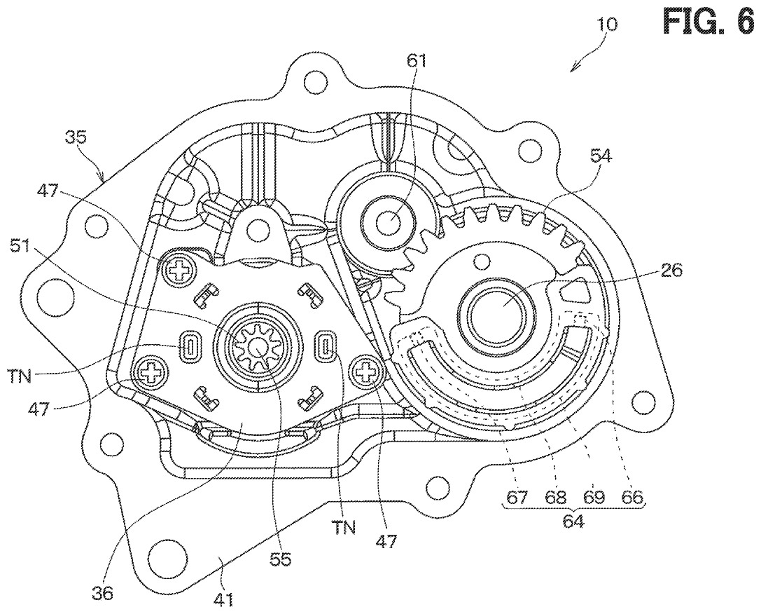

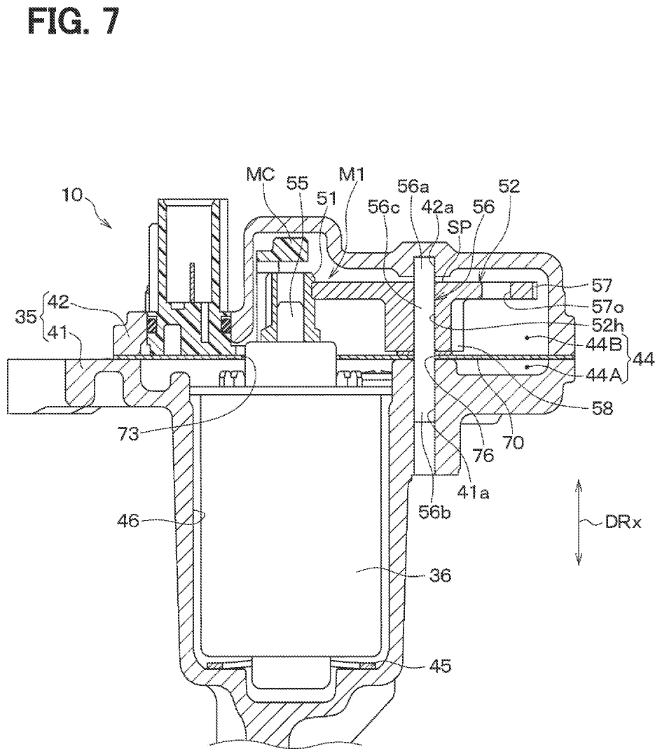

As shown in FIGS. 7, 8 and 9, the actuator 10 includes a speed reducer 37. The speed reducer 37 transmits rotation of the electric motor 36 to the output shaft 26 after reducing a rotational speed of the rotation. The speed reducer 37 is a parallel shaft type speed reducer and has a plurality of gears. In the present embodiment, the plurality of gears of the speed reducer 37 include a pinion gear 51, a first intermediate gear 52, a second intermediate gear 53 and an output gear 54.

The pinion gear 51 is fixed to the motor shaft 55 of the electric motor 36. The pinion gear 51 is positioned in the case side space 44B of the internal space 44. The pinion gear 51 is a gear made of metal. The pinion gear 51 is made of, for example, iron-based sintered metal. Hereinafter, a gear, which has a plurality of teeth made of metal, may be also referred to as a metal gear.

The first intermediate gear 52 is a compound gear that has a first large diameter portion 57 and a first small diameter portion 58. The first intermediate gear 52 is positioned in the case side space 44B of the internal space 44. The first intermediate gear 52 is placed such that the first large diameter portion 57 is located at the housing case 42 side, and the first small diameter portion 58 is located at the housing main body 41 side.

The first large diameter portion 57 is a large diameter gear and is meshed with the pinion gear 51 that is fixed to the motor shaft 55 of the electric motor 36. The first large diameter portion 57 is a metal gear having a plurality of teeth made of metal. The first large diameter portion 57 is made of, for example, iron-based sintered metal.

The first small diameter portion 58 is a small diameter gear that has a diameter smaller than that of the first large diameter portion 57. The first large diameter portion 57 has a plurality of openings 57o to reduce the inertia thereof. The first small diameter portion 58 is a metal gear having a plurality of teeth made of metal. The first small diameter portion 58 is made of, for example, iron-based sintered metal. The first intermediate gear 52 is rotatably supported by a first intermediate shaft 56 made of metal. The first intermediate gear 52 is rotated about the first intermediate shaft 56. Specifically, the first intermediate gear 52 has a first insertion hole 52h, through which the first intermediate shaft 56 is inserted.

The second intermediate gear 53 is a compound gear that has a second large diameter portion 62 and a second small diameter portion 63. The second intermediate gear 53 extends in both the main-body side space 44A and the case side space 44B in the internal space 44. The second intermediate gear 53 is placed such that the second large diameter portion 62 is placed in the case side space 44B of the internal space 44, and the second small diameter portion 63 is placed in the main-body side space 44A of the internal space 44. That is, the second intermediate gear 53 is placed such that the second large diameter portion 62 is placed at the housing case 42 side, and the second small diameter portion 63 is placed at the housing main body 41 side.

The second large diameter portion 62 is a large diameter gear and is meshed with the first small diameter portion 58 of the first intermediate gear 52. The second large diameter portion 62 is a metal gear having a plurality of teeth made of metal. The second large diameter portion 62 is made of, for example, iron-based sintered metal.

The second large diameter portion 62 is located on the housing main body 41 side of the first large diameter portion 57. A portion of the second large diameter portion 62 overlaps with the first large diameter portion 57, which is the metal gear, in the axial direction DRx. Furthermore, another portion of the second large diameter portion 62 overlaps with the output gear 54, which has the teeth made of the resin, in the axial direction DRx. Here, the axial direction DRx is defined as a direction that is parallel with a rotational axis of the respective gears of the speed reducer 37.

The second small diameter portion 63 is a small diameter gear that has a diameter smaller than that of the second large diameter portion 62. The second small diameter portion 63 is a gear made of resin. The second small diameter portion 63 is made of a fiber-reinforced resin material obtained by impregnating resin with reinforcing fibers. For example, polyamide resin, nylon resin or polyacetal resin may be used as the resin of the second small diameter portion 63. Furthermore, a filler, such as glass fibers or carbon fibers, may be used as the reinforcing fibers. Hereinafter, a gear, which has a plurality of teeth made of resin, may be also referred to as a resin gear.

The second small diameter portion 63 is formed integrally with the second large diameter portion 62, which is the metal gear, in one-piece. Here, the expression of forming the resin gear and the metal gear in one-piece means that the resin gear is formed by, for example, injection molding as a single mass that cannot be disassembled without being destroyed while the resin gear is joined to the metal gear without leaving a gap between the resin gear and the metal gear. Besides the injection molding, the resin molding may be any other suitable type of resin molding, such as laminate molding, powder molding.

Specifically, the second intermediate gear 53 has the second large diameter portion 62, which is the metal gear and is placed at the outer side of the second intermediate gear 53, and the second small diameter portion 63, which is the resin gear and is placed at the inner side of the second intermediate gear 53. The second small diameter portion 63 has a second insertion hole 53h, through which a second intermediate shaft 61 is inserted. By forming the second insertion hole 53h in the second small diameter portion 63, which is the resin gear, the number of the components of the actuator 10 can be reduced, and the number of assembling steps of the actuator 10 can be reduced.

Here, it should be noted that the inertia of the resin gear is smaller than the inertia of the metal gear. Therefore, in a case where a large impact load, which is generated due to the pulsation of the exhaust gas pressure of the engine 11, is applied to the second intermediate gear 53 through various structures, this impact is less likely to be transmitted to the gears, such as the first intermediate gear 52 and the pinion gear 51, which are located on the motor 36 side of the second intermediate gear 53.

The second intermediate gear 53 is rotatably supported by the second intermediate shaft 61 which is made of the metal. The second intermediate gear 53 is rotated about the second intermediate shaft 61. Specifically, the second intermediate gear 53 has the second insertion hole 53h, through which the second intermediate shaft 61 is inserted.

Here, in the speed reducer 37, the pinion gear 51 and the first large diameter portion 57 serve as a pair of metal gears, and the first small diameter portion 58 and the second large diameter portion 62 serve as another pair of metal gears. Furthermore, in the speed reducer 37, one of the second small diameter portion 63 and the output gear 54 serves as a resin gear, and the other one of the second small diameter portion 63 and the output gear 54 serves as a mating gear. Furthermore, in the speed reducer 37, the first intermediate gear 52 serves as a compound gear made of metal, and the second intermediate gear 53 serves as a driven gear which has a plurality of teeth made of resin and is located on the output side of the compound gear made of the metal.

The output gear 54 is fixed to the output shaft 26. The output gear 54 is located in the main-body side space 44A of the internal space 44. The output gear 54 is a resin gear which has a plurality of teeth made of resin. A material of the output gear 54 is the same as the material of the second small diameter portion 63. The output gear 54 is meshed with the second small diameter portion 63. Therefore, in a case where a large impact load is to applied to the output gear 54, when the output gear 54 is formed as the resin gear, the impact is less likely to be transmitted to the output gear 54 and the gears, such as the second intermediate gear 53, the first intermediate gear 52 and the pinion gear 51, which are located on the motor 36 side of the output gear 54.

In the present embodiment, the gears, which are arranged in the transmission path from the pinion gear 51 of the electric motor 36 to the second large diameter portion 62, are the metal gears, and the gears, which are from the second small diameter portion 63 to the output gear 54 on the output side, are the resin gears. Specifically, the gears of the speed reducer 37, which are other than the the output gear 54 and the second small diameter portion 63 of the second intermediate gear 53 are the metal gears.

Specifically, the speed reducer 37 includes: a first metal meshing portion M1, which is a meshing portion between the pinion gear 51 and the first large diameter portion 57; and a second metal meshing portion M2, which is a meshing portion between the first small diameter portion 58 and the second large diameter portion 62. Furthermore, the actuator 10 includes a resin meshing portion M3, which is a meshing portion between the second small diameter portion 63 and the output gear 54.

As described above, in the speed reducer 37 of the present embodiment, the meshing of the gears include only the resin gear to resin gear meshing or the metal gear to metal gear meshing, and there is no resin gear to metal gear meshing. Therefore, it is possible to limit the wearing of the resin gears.

Furthermore, in the speed reducer 37, the pinion gear 51, the first intermediate gear 52 and the second large diameter portion 62, which are made of the metal, are located in the case side space 44B, and the second small diameter portion 63 and the output gear 54, which are made of the resin, are located in the main-body side space 44A. That is, in the speed reducer 37, the metal gears are located in the case side space 44B, and the resin gears are located in the main-body side space 44A.

Furthermore, in the speed reducer 37, the pinion gear 51, the first intermediate gear 52 and the second large diameter portion 62, which are made of the metal, are located in the case side space 44B, and the second small diameter portion 63 and the output gear 54, which are made of the resin, are located in the main-body side space 44A. That is, in the speed reducer 37, the metal gears are located in the case side space 44B, and the resin gears are located in the main-body side space 44A.

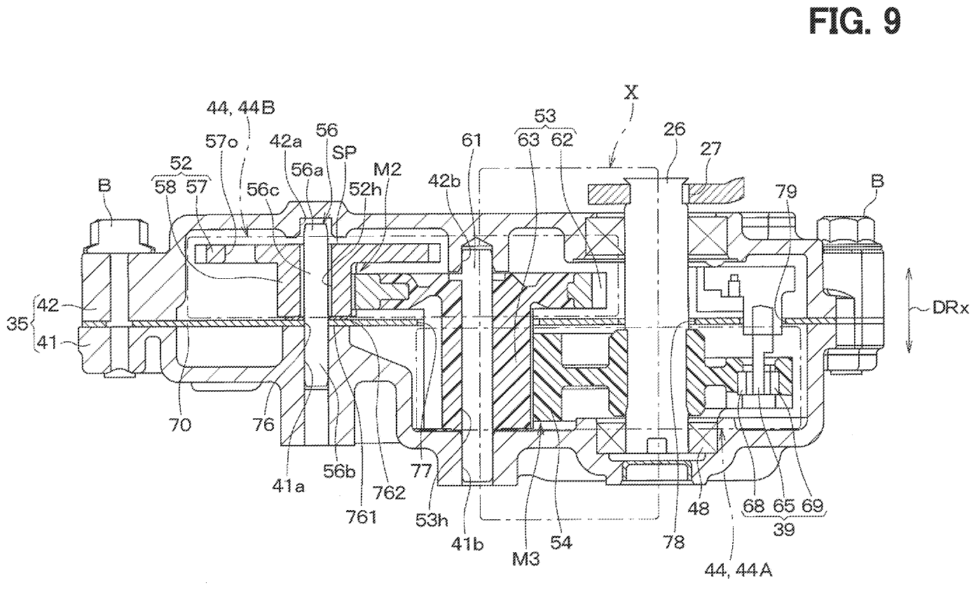

As shown in FIGS. 7 and 9, one end portion of the first intermediate shaft 56 is supported by the housing case 42, and the other end portion of the first intermediate shaft 56 is supported by the housing main body 41. The first intermediate shaft 56 is fixed to the housing main body 41.

Specifically, the one end portion 56a of the first intermediate shaft 56, which is located on the housing case 42 side, is fitted into a first fitting hole 42a of the housing case 42. The other end portion 56b of the first intermediate shaft 56 located on the housing main body 41 side is press-fitted into a first press-fit hole 41a of the housing main body 41. The first intermediate shaft 56 has an intermediate portion 56c located between the one end portion 56a and the other end portion 56b, and the first intermediate gear 52 is rotatably supported by the intermediate portion 56c. A diameter of the first insertion hole 52h of the first intermediate gear 52 and an outer diameter of the first intermediate shaft 56 are set to corresponding values that enable clearance fit between the first intermediate gear 52 and the first intermediate shaft 56.

In the present embodiment, the first fitting hole 42a serves as a first intermediate support portion which supports the end portion of the first intermediate shaft 56 located on the large diameter gear side, and the first press-fit hole 41a serves as a second intermediate support portion which supports the end portion of the first intermediate shaft 56 located on the small diameter gear side.

Similarly, one end portion of the second intermediate shaft 61 is supported by the housing case 42, and the other end portion of the second intermediate shaft 61 is supported by the housing main body 41. Specifically, the second intermediate shaft 61 is fixed to the housing main body 41. With this structure, in comparison to a structure, in which only one end portion of the second intermediate shaft 61 is supported by the housing 35, it is possible to reduce the amount of deformation of the second intermediate shaft 61 caused by vibrations and/or a torque generated by, for example, the operation of the electric motor 36 and/or pulsation of the wastegate valve 19.

Specifically, the one end portion of the second intermediate shaft 61, which is located on the housing case 42 side, is fitted into a second fitting hole 42b of the housing case 42. The other end portion of the second intermediate shaft 61, which is located on the housing main body 41 side, is fitted into a second press-fit hole 41b of the housing main body 41. The second intermediate gear 53 is rotatably supported by an intermediate portion of the second intermediate shaft 61 which is located between the one end portion and the other end portion of the second intermediate shaft 61. A diameter of the second insertion hole 53h of the second intermediate gear 53 and an outer diameter of the second intermediate shaft 61 are set to corresponding values that enable clearance fit between the second intermediate gear 53 and the second intermediate shaft 61.

As shown in FIG. 6, the output gear 54 has magnets 66, 67, which serve as magnetic flux generating portions, and yokes 68, 69, which serve as magnetic flux transmitting portions. The magnets 66, 67 and the yokes 68, 69 form a magnetic circuit device 64 that forms a closed magnetic circuit shaped in an arcuate form. The magnetic circuit device 64 is rotatable integrally with the output gear 54 and the output shaft 26.

As shown in FIG. 9, a sensing device 65, which senses a magnetic flux of the magnets 66, 67, is located at an inside of the closed magnetic circuit of the magnetic circuit device 64 of the output gear 54. The sensing device 65 is formed with, for example, a Hall IC. The magnetic circuit device 64 and the sensing device 65 function as a rotational angle sensor 39 that senses a rotational angle of the output shaft 26. The rotational angle of the output shaft 26, which is sensed by the rotational angle sensor 39, is outputted to the ECU 22.

Here, the rotational angle sensor 39 is installed to the output gear 54. Therefore, like the output gear 54, the rotational angle sensor 39 is located in the main-body side space 44A of the internal space 44.

The output shaft 26 is rotatably supported by a bearing 48, which is installed to the housing main body 41, and a bearing 49, which is installed to the housing case 42. One end portion of the output shaft 26 outwardly projects from the housing case 42 of the housing 35. The actuator lever 27 is fixed to the output shaft 26 at the outside of the housing case 42.

A stress, which is generated by engine pulsations, is applied to the actuator 10, which is configured in the above-described manner, through the wastegate valve 19. A high periodic impact load, which is caused by the pulsation period, is applied to the output shaft 26, so that the speed reducer 37 needs to have the wear resistance and the strength.

With respect to this, in the actuator 10 of the present embodiment, grease G, which is lubricant, is applied to locations where wear is concerned at the speed reducer 37. Hereinafter, the application locations of the grease G at the speed reducer 37 will be described.

(Application Location between Gears)

Hereinafter, first, the application location of the grease G between the gears of the speed reducer 37 will be described. In order to improve the wear resistance, it is effective to apply the grease G to the metal gear. However, according to the investigation of the inventors of the present application, it is found that in a case where the grease G adheres to the resin gear, the resin wear particles, which are generated at the time of applying the high stress to the resin gear, are held by the grease G, so that wearing of the resin gear is easily promoted. Particularly, like in the present embodiment, in the case where the resin gear is made of the fiber-reinforced resin material, due to the presence of the fibers in the wear particles, the wear of the resin gear becomes remarkable. As discussed above, in the actuator 10, which drives the boost pressure control valve, it is not desirable to adhere the grease G to the resin gear in view of the wear resistance.

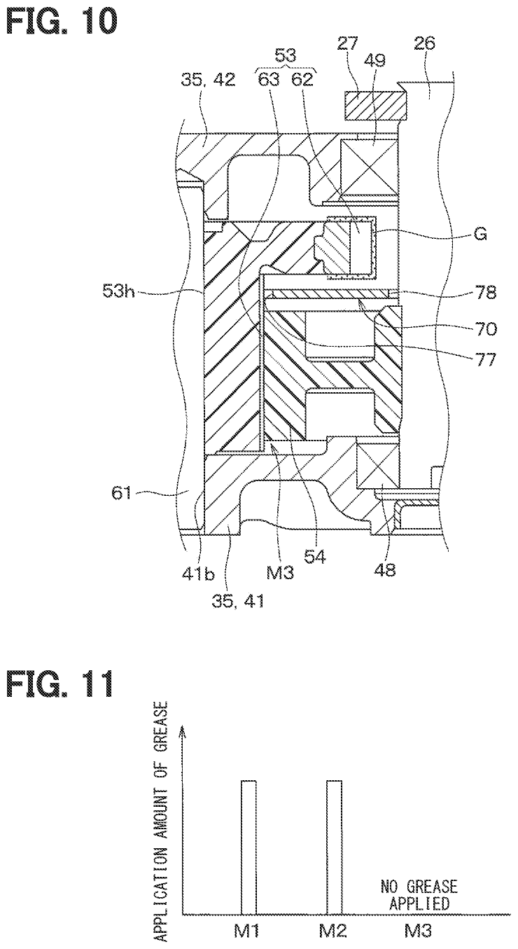

In view of the above points, in the speed reducer 37, the grease G is applied more to some of the gear-to-gear meshing portions than another one of the gear-to-gear meshing portions in the speed reducer 37. That is, in the speed reducer 37, the grease G is applied more to the first metal meshing portion M1 and the second metal meshing portion M2 than the resin meshing portion M3. For example, as shown in FIG. 10, the grease G is applied to a surface of the second large diameter portion 62, which forms the second metal meshing portion M2. The grease G is applied to the surface of the second large diameter portion 62 to have a predetermined thickness of the grease G. Specifically, as shown in FIG. 11, the grease G is applied to the first metal meshing portion M1 and the second metal meshing portion M2 and is not applied to the resin meshing portion M3.

(Application Location between Gear and Shaft)

Next, the application location between the gear and the shaft in the speed reducer 37 will be described. In the speed reducer 37, the grease G is applied between the first intermediate gear 52, which is the compound gear made of the metal, and the first intermediate shaft 56, which is the intermediate shaft made of the metal. In the speed reducer 37, the grease G is not applied between the second intermediate gear 53 and the second intermediate shaft 61 made of the metal.

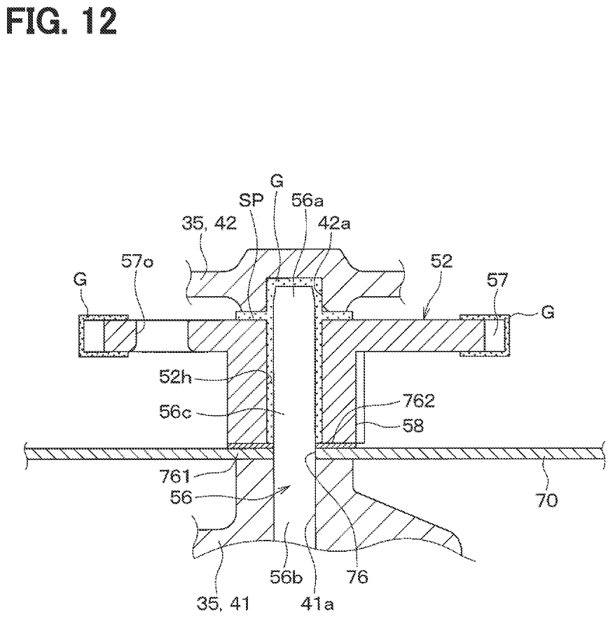

Here, in FIGS. 10 and 12, the location, at which the grease G is applied, is indicated with a dot pattern hatching to ease the understanding of the application location of the grease G. As shown in FIG. 12, the grease G is applied more to the first large-diameter portion (i.e., the large diameter gear) 57 side of the first intermediate shaft 56 than the first small diameter portion (i.e., the small diameter gear) 58 side of the first intermediate shaft 56. Specifically, the grease G is applied to the intermediate portion 56c of the first intermediate shaft 56 which supports the first intermediate gear 52. The grease G is substantially evenly applied between the first intermediate shaft 56 and the first insertion hole 52h of the first intermediate gear 52.

Furthermore, the grease G is applied to the one end portion 56a of the first intermediate shaft 56 and the first fitting hole 42a of the housing case 42 and is not applied between the other end portion 56b of the first intermediate shaft 56 and the first press-fit hole 41a of the housing main body 41. Specifically, the first fitting hole 42a is a blind hole that has a hole depth which is set such that a bottom surface of the blind hole does not contact the one end portion 56a of the first intermediate shaft 56. A space, which is surrounded by the first fitting hole 42a and the one end portion 56a, is a space for accumulating the grease G.

Furthermore, the grease G is applied between the first large diameter portion (i.e., the large diameter gear) 57 and the housing case 42 and is not applied between the first small diameter portion (i.e., the small diameter gear) 58 and the intermediate plate 70. Specifically, the grease G is applied to a sliding portion SP of the housing case 42, along which the first large diameter portion 57 slides. The sliding portion SP is a portion of the housing case 42, which is opposed to the first large diameter portion 57 in the axial direction DRx.

In the actuator 10 described above, instead of applying the grease G throughout the entire sliding portions in the speed reducer 37, the application locations of the grease G in the speed reducer 37 are appropriately set. Therefore, it is possible to implement the actuator 10 that is excellent in the wear resistance.

### (Details of Intermediate Plate 70)

Next, the details of the intermediate plate 70 will be described. The intermediate plate 70 is a plate member that limits scattering of a scattering object, which is generated in response to the operation of the speed reducer 37 and is scattered from the metal gear, to the other space of the internal space 44 of the housing 35, which is other than the space in which the metal gears are located.

The intermediate plate 70 is obtained by processing a plate material made of metal. Like the housing 35, the intermediate plate 70 is made of the metal material, such as aluminum, an aluminum alloy or steel.

As shown in FIGS. 7, 8 and 9, the intermediate plate 70 extends in a direction perpendicular to the axial direction DRx such that the intermediate plate 70 extends across the internal space 44 of the housing 35 in the direction perpendicular to the axial direction DRx. The internal space 44 of the housing 35 is partitioned by the intermediate plate 70 into the case side space 44B, in which the metal gears are located, and the main-body side space 44A, in which the resin gear, the mating gear, the magnetic circuit device 64 and the sensing device 65 are located.

The intermediate plate 70 has a contact portion 71 that entirely contacts a coupling surface of the housing main body 41 and a coupling surface of the housing case 42, which are opposed to each other and are coupled together. The contact portion 71 is a portion that is interposed between the housing main body 41 and the housing case 42. The contact portion 71 is interposed between the housing main body 41 and the housing case 42 to seal between the coupling surface of the housing main body 41 and the coupling surface of the housing case 42. Specifically, the intermediate plate 70 also functions as a gasket that implements the gas tightness and the liquid tightness of the housing 35.

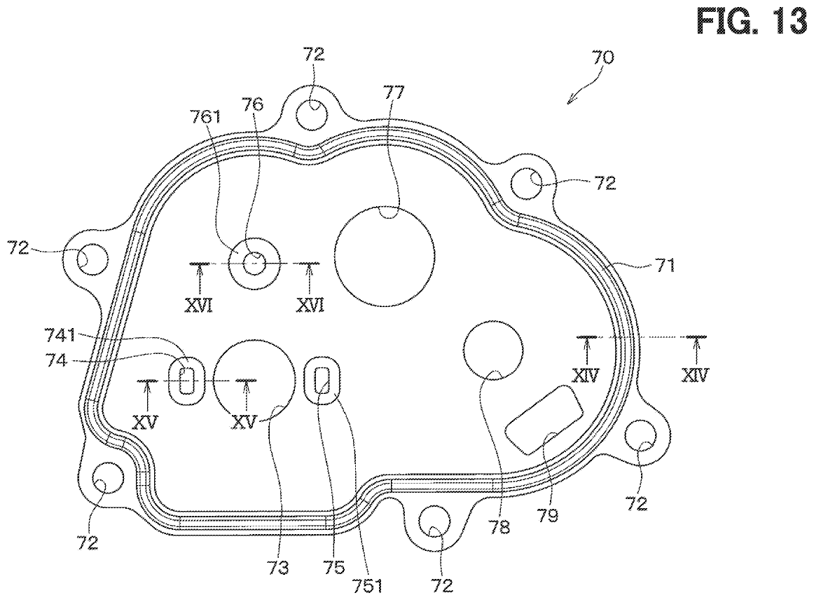

As shown in FIGS. 13 and 14, the surface of the contact portion 71 is coated with a seal material 711. As the seal material 711, for example, a material having excellent sealing properties such as a rubber material and a resin material can be used.

A bead 712, which is bent to rise from the housing main body 41 side toward the housing case 42, is formed to extend all along the contact portion 71. The bead 712 is squashed when the housing main body 41 and the housing case 42 are joined together. By squashing the bead 712, the degree of close contact between the housing main body 41 and the housing case 42 is increased. The bead 712 may rise from the housing case 42 side toward the housing main body 41.

Furthermore, a plurality of through-holes are formed to extend through the intermediate plate 70. A plurality of fastening holes 72, through which fastening members B for fastening the housing main body 41 and the housing case 42 together are inserted, are formed to extend through the contact portion 71 of the intermediate plate 70. The fastening holes 72 are formed on an outer side of the bead 712.

Furthermore, a motor shaft hole 73, a pair of terminal holes 74, 75, a first intermediate shaft hole 76, a second intermediate shaft hole 77, an output shaft hole 78 and a sensor hole 79 are formed at the intermediate plate 70 at a location that is on an inner side of the bead 712.

The motor shaft hole 73 is a through-hole, through which the motor shaft 55 and the pinion gear 51 are inserted. A size of the motor shaft hole 73 is slightly larger than that of the pinion gear 51 to enable insertion of the pinion gear 51 through the motor shaft hole 73.

The terminal holes 74, 75 are through-holes, through which the pair of terminals TN are inserted. The terminal holes 74, 75 are formed at the intermediate plate 70 at two locations, respectively, which are located on one side and another side of the motor shaft hole 73 in a radial direction of the motor shaft hole 73. A size of each of the terminal holes 74, 75 is slightly larger than that of the corresponding one of the terminals TN to enable insertion of the terminal TN through the terminal hole 74, 75. A dielectric coating 741, 751 is formed at a periphery of each of the terminal holes 74, 75 to electrically insulate between the intermediate plate 70 and the terminal TN. As the dielectric coating 741, 751, for example, a material having good dielectricity such as a rubber material and a resin material can be used.

The first intermediate shaft hole 76 is a through-hole, through which the first intermediate shaft 56 is inserted. A size of the first intermediate shaft hole 76 is slightly larger than that of the first intermediate shaft 56 to enable insertion of the first intermediate shaft 56 through the first intermediate shaft hole 76. Furthermore, the size of the first intermediate shaft hole 76 is slightly smaller than an outer diameter of the first intermediate gear 52. A hole peripheral edge portion 761 of the first intermediate shaft hole 76 is opposed to the first small diameter portion 58 of the first intermediate gear 52.

Since the first intermediate gear 52 is not fixed to the first intermediate shaft 56, the first intermediate gear 52 may contact the hole peripheral edge portion 761 when the first intermediate gear 52 is displaced in the axial direction DRx. The hole peripheral edge portion 761 forms a sliding surface, which is opposed to the first small diameter portion 58 that is the metal gear, while the sliding surface is slidable relative to the metal gear. When the first intermediate gear 52, which is the metal gear, is rotated in a state where the first intermediate gear 52 contacts the hole peripheral edge portion 761, the first intermediate gear 52 and the hole peripheral edge portion 761 are worn.

In view of this point, a washer 762 is provided to a surface of the hole peripheral edge portion 761, which is opposed to the first small diameter portion 58, as shown in FIG. 16. The washer 762 is a sliding member that forms the sliding surface which slidably contacts the first small diameter portion 58. By interposing the washer 762 between the first intermediate gear 52 and the hole peripheral edge portion 761, the wear of the hole peripheral edge portion 761 caused by the sliding of the first intermediate gear 52 is limited.

The second intermediate shaft hole 77 is a through-hole, through which the second intermediate shaft 61 and the second small diameter portion 63 of the second intermediate gear 53 are inserted. A size of the second intermediate shaft hole 77 is slightly larger than that of the second intermediate shaft 61 to enable insertion of the second intermediate shaft 61 through the second intermediate shaft hole 77. Furthermore, the size of the second intermediate shaft hole 77 is slightly smaller than an outer diameter of the second large diameter portion 62 of the second intermediate gear 53.

The output shaft hole 78 is a through-hole, through which the output shaft 26 is inserted. A size of the output shaft hole 78 is slightly larger than that of the output shaft 26 to enable insertion of the output shaft 26 through the output shaft hole 78. Furthermore, the size of the output shaft hole 78 is slightly smaller than an outer diameter of the output gear 54.

The sensor hole 79 is a through-hole, through which lead wires Ld for outputting a measurement signal from the sensing device 65 of the rotational angle sensor 39 are inserted. The sensor hole 79 is formed at the intermediate plate 70 at a location which is opposed to the sensing device 65 in the axial direction DRx.

### (Assembling Method of Gears)

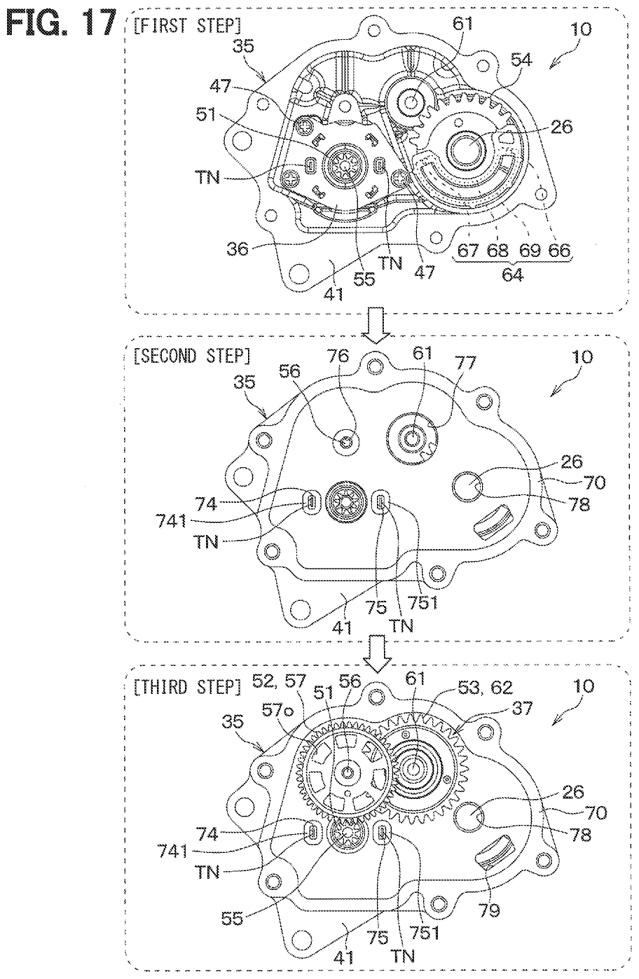

Next, an assembling method of the gears of the speed reducer 37 will be described with reference to FIG. 17. As shown in FIG. 17. the gears of the speed reducer 37 are assembled through a first step, a second step and a third step.

First, at the first step, the electric motor 36 having the motor shaft 55, to which the pinion gear 51 is installed, is fixed to the housing main body 41 by screws 47 in a state where the electric motor 36 is inserted in the motor insertion hole 46. Furthermore, at the first step, the output gear 54, to which the rotational angle sensor 39 is integrated, is installed to the output shaft 26, and the output shaft 26 is rotatably installed to the housing main body 41.

Next, at second step, the intermediate plate 70 is assembled to the housing main body 41. At this time, some of the components at the housing main body 41 side are inserted through the corresponding through-holes of the intermediate plate 70. Specifically, the motor shaft 55 and the pinion gear 51 are inserted through the motor shaft hole 73. The pair of terminals TN are inserted through the pair of terminal holes 74, 75, respectively. The first intermediate shaft 56 is inserted through the first intermediate shaft hole 76. The second intermediate shaft 61 is inserted through the second intermediate shaft hole 77. The output shaft 26 is inserted through the output shaft hole 78. Therefore, the motor shaft 55, the pinion gear 51, the pair of terminals TN, the first intermediate shaft 56 and the second intermediate shaft 61 project outward from the inside of the housing main body 41 through the intermediate plate 70.

Next, at the third step, the gears are assembled to the pinion gear 51, the first intermediate shaft 56 and the second intermediate shaft 61, which project from the intermediate plate 70. Specifically, the second intermediate gear 53 is installed to the second intermediate shaft 61 and is meshed with the output gear 54. Furthermore, the first intermediate gear 52 is installed to the first intermediate shaft 56, and the pinion gear 51 and the second intermediate gear 53 are meshed with each other. The grease G is applied to predetermined locations described above before/after the assembling of the first intermediate gear 52.

As described above, the housing case 42 is assembled to the housing main body 41, to which the intermediate plate 70 is assembled, after the assembling of the gears of the speed reducer 37. Then, the housing main body 41 and the housing case 42 are fixed together by the fastening members B. At this time, the bead 712, which is formed at the intermediate plate 70, is squashed, so that the housing main body 41 and the housing case 42 come into close contact with each other.

Therefore, there is implemented the actuator 10 that can limit the disadvantage caused by the scattering of the scattering object generated from the metal gear while ensuring the wear resistance.

(Application of Grease between Gears)

The grease (serving as the lubricant) G is applied more to the first metal meshing portion M1 and the second metal meshing portion M2 than the resin meshing portion M3 in the speed reducer 37. Therefore, the wearing of the first metal meshing portion M1 and the second metal meshing portion M2 can be sufficiently reduced. In addition, in the speed reducer 37, the amount of grease G applied to the resin meshing portion M3 is small, so that the wear particles of the resin are less likely to be held by the grease G, and therefore it is possible to limit the wearing of the resin meshing portion M3.

Specifically, the grease G is applied to the first metal meshing portion M1 and the second metal meshing portion M2 and is not applied to the resin meshing portion M3. Therefore, the wearing of the first metal meshing portion M1 and the second metal meshing portion M2 can be reduced by the grease G, and the wearing of the resin meshing portion M3, which is caused by the holding of the wear particles of the resin by the grease G, can be sufficiently limited.

Furthermore, among the first metal meshing portion M1 and the second metal meshing portion M2, the second metal meshing portion M2 is placed closer to the resin meshing portion M3, and a minimum gap of the second metal meshing portion M2 relative to the resin meshing portion M3, is set to be larger than the thickness TH of the grease G applied to the second metal meshing portion M2. Therefore, the grease G, which is applied to the first metal meshing portion M1 and the second metal meshing portion M2, is less likely to adhere to the resin meshing portion M3 at the time of operating the speed reducer 37.

Furthermore, the second large diameter portion 62, which is the metal gear, is formed as the compound gear together with one of the resin gear and the mating gear of the resin meshing portion M3 to coaxially and integrally rotate with the one of the resin gear and the mating gear of the resin meshing portion M3. In addition, the second large diameter portion 62 has a resin overlapping portion DP2 that overlaps with the other one of the resin gear and the mating gear of the resin meshing portion M3 in the axial direction DRx. A gap measured in the axial direction DRx between the resin overlapping portion DP2 and the other one of the resin gear and the mating gear of the resin meshing portion M3 is set to be larger than the thickness of the grease G applied to the resin overlapping portion DP2. Therefore, at the time of operating the speed reducer 37, the grease G, which is applied to the resin overlapping portion DP2, is less likely to adhere to the output gear 54.

Furthermore, in the present embodiment, the resin gear is made of the fiber-reinforced resin material obtained by impregnating the resin with reinforcing fibers. Therefore, if the grease G adheres to the resin gear, the fibers are also held by the grease G in addition to the wear particles to promote the wearing of the resin gear. Therefore, the actuator 10, in which the grease G is applied more to the first metal meshing portion M1 and the second metal meshing portion M2 than the resin meshing portion M3, is suitable as the actuator, in which the resin gear of the speed reducer 37 is made of the fiber-reinforced resin material.

(Application of Grease between Gear and Shaft)

The speed reducer 37 of the present embodiment includes the first intermediate gear 52 and the second intermediate gear 53. The first intermediate gear 52 is made of the metal and has the large diameter gear and the small diameter gear while the diameter of the small diameter gear is smaller than that of the large diameter gear. The second intermediate gear 53 is located on the output side of the first intermediate gear 52 and has the teeth made of the resin. The second intermediate gear 53 is placed to oppose the small diameter gear of the first intermediate gear 52 to mesh with the small diameter gear of the first intermediate gear 52. The grease G is applied between the first intermediate gear 52 and the first intermediate shaft 56. The grease G is applied more to the large diameter gear side than the small diameter gear side along the first intermediate shaft 56.

Therefore, the grease G, which is interposed between the first intermediate gear 52 and the first intermediate shaft 56, can limit the wearing between the first intermediate gear 52 and the first intermediate shaft 56. In addition, since the grease G is applied more to the large diameter gear side than the small diameter gear side along the first intermediate shaft 56, the grease G is less likely to adhere to the driven gear having the resin teeth. Therefore, it is possible to limit the wearing of the second intermediate gear 53 caused by holding of the wear particles of the resin by the grease G.

Furthermore, the grease G is applied to the first fitting hole 42a, which forms the first intermediate support portion incorporation with the first intermediate shaft 56, and the grease G is not applied to the first press-fit hole 41a, which forms the second intermediate support portion in corporation with the first intermediate shaft 56. Therefore, the grease G, which is scattered at the time of operating the speed reducer 37, is less likely to adhere to the second intermediate gear 53 having the teeth made of the resin. Thus, it is possible to limit the wearing of the second intermediate gear 53 caused by holding of the wear particles of the resin by the grease G.

In addition, a storage space GS, which stores the excess amount of grease G, is formed between the first intermediate shaft 56 and the first fitting hole 42a. In the case where the storage space GS is formed at the large diameter gear side rather than the small diameter gear side of the first intermediate gear 52, it is possible to limit the grease G from adhering to the second intermediate gear 53 having the teeth made of the resin while ensuring the lubricity on the large diameter gear side.

Furthermore, the grease G is applied between the first large diameter portion (i.e., the large diameter gear) 57 and the housing case 42 and is not applied between the first small diameter portion (i.e., the small diameter gear) 58 and the housing main body 41 Therefore, since the grease G is applied to the large diameter gear of the first intermediate gear 52, it is possible to limit the wearing of the large diameter gear in response to the sliding between the large diameter gear and the housing case 42. Furthermore, since the grease G is not applied to the small diameter gear side of the first intermediate gear 52, it is possible to limit adhesion of the grease G to the second intermediate gear 53 having the teeth made of the resin.

(Countermeasures against Scattering Object from Metal Gear Side)

The actuator 10 includes the intermediate plate 70 that limits scattering of the scattering object, which is generated in response to the operation of the speed reducer 37 and is scattered from the metal gear, to the other space (predetermined space) of the internal space 44 of the housing 35, which is other than the space in which the metal gears are located. With this structure, the intermediate plate 70 limits the scattering of the scattering object from the metal gear to the other space, so that it is possible to limit the disadvantage caused by the scattering of the scattering object from the metal gear to the predetermined space.

Specifically, the internal space 44 of the housing 35 is partitioned by the intermediate plate 70 into the case side space 44B, in which the metal gears are located, and the main-body side space 44A, in which the resin gear and the mating gear are located. With this structure, at the time of operating the speed reducer 37, the intermediate plate 70 limits the scattering of the grease G, which is applied to the metal gear, to the main-body side space 44A in which the resin gear and the mating gear are located in the internal space 44 of the housing 35. Therefore, since the wear particles of the resin are less likely to be held by the grease G, it is possible to limit the wearing of the resin meshing portion M3. Specifically, it is possible to limit the disadvantage caused by the scattering of the scattering object (i.e., the grease G) from the metal gear to the space, in which the resin gears are located.

The rotational angle sensor 39 of the present embodiment is the magnetism sensing type sensor that includes the magnetic circuit device 64 and the sensing device 65. In this type of sensor, when the wear particles generated from the metal gear adhere to the sensor as the magnetic object, the sensing accuracy of the sensor may possibly be deteriorated.

In contrast, the internal space 44 of the housing 35 is partitioned by the intermediate plate 70 into the one space, in which the metal gears are located, and the other space, in which the magnetic circuit device 64 and the sensing device 65 are located. With this structure, the intermediate plate 70 limits the scattering of the wear particles, which are generated from the metal gear at the time of operating the speed reducer 37, to the other space, in which the magnetic circuit device 64 and the sensing device 65 are located in the internal space 44 of the housing 35. Therefore, the wear particles, which are generated at the metal gear, are less likely to adhere to the magnetic circuit device 64 and the sensing device 65, so that it is possible to limit an unintended change in the output of the rotational angle sensor 39. Specifically, it is possible to limit the disadvantage caused by the scattering of the scattering object (i.e., the metal particles) from the metal gear to the space, in which the magnetic circuit device 64 and the sensing device 65 are located.

The intermediate plate 70 seals between the housing main body 41 and the housing case 42. Therefore, the intermediate plate 70 can function as the gasket that seals between the housing main body 41 and the housing case 42. In addition, the gas tightness and the liquid tightness of the housing 35 can be improved without increasing the number of components, and the intermediate plate 70 can limit the scattering of the scattering object from the metal gear to the outside of the housing 35.

For example, in a case where the connection between the housing main body 41 and the housing case 42 is sealed by an 0-ring, a groove, which receives the O-ring, needs to be formed in at least one of the coupling surface of the housing main body 41 and the coupling surface of the housing case 42.

In contrast, when the intermediate plate 70 is used as the gasket, it is possible to seal between the housing main body 41 and the housing case 42 without a need for processing the coupling surface of the housing main body 41 and the coupling surface of the housing case 42.

Furthermore, the seal material 711 is coated to the contact portion 71 of the intermediate plate 70 which is interposed between the housing main body 41 and the housing case 42. In addition, the intermediate plate 70 has the bead 712 that is squashed when the housing main body 41 and the housing case 42 are joined together. Thus, the housing main body 41 and the housing case 42 come into close contact with each other by squashing the bead 712, and thereby the degree of sealing between the housing main body 41 and the housing case 42 can be improved.

Furthermore, the washer 762, which forms the sliding surface relative to the first intermediate gear 52, is installed to the portion (i.e., the hole peripheral edge portion 761) of the intermediate plate 70 which is opposed to the first intermediate gear (the metal gear) 52. Therefore, it is possible to limit the wearing of the intermediate plate 70 and the first intermediate gear 52, which is caused by the sliding between the intermediate plate 70 and the first intermediate gear 52.

The dielectric coating 741, 751 is formed at the periphery of each of the terminal holes 74, 75, through which the corresponding one of the pair of terminals TN of the electric motor 36 is inserted, to electrically insulate between the intermediate plate 70 and the terminal TN. Therefore, it is possible to limit the electric short-circuiting of the electric motor 36 via the intermediate plate 70.

The stress, which is caused by the engine pulsation, is applied to the actuator 10, which drives the boost pressure control valve, through the wastegate valve (the boost pressure control valve) 19. The high periodic impact load, which is caused by the pulsation period, is applied to the output shaft 26, so that the scattering object (e.g., the grease G and the wear particles) is likely to be scattered from the metal gear to the other space. Therefore, the structure, which includes the intermediate plate 70 to limit the scattering of the scattering object from the metal gear to the predetermined space, is advantageous for the actuator 10 that drives the boost pressure control valve of the supercharger 24.

### (First Modification)

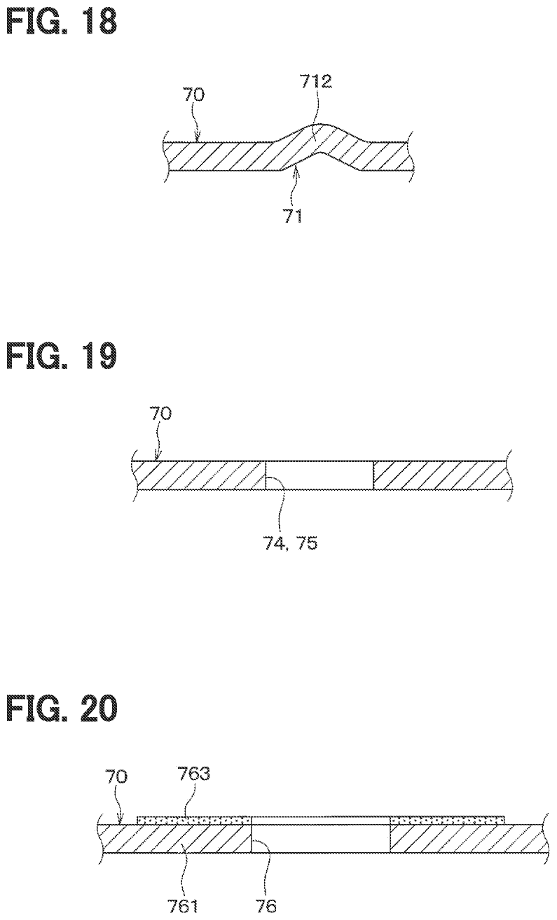

In the above embodiment, there is described the example where the seal material 711 is coated to the contact portion 71 of the intermediate plate 70. However, the intermediate plate 70 is not limited to this. For example, as shown in FIG. 18, the intermediate plate 70 may not have the seal material 711 coated at the contact portion 71. Furthermore, the intermediate plate 70 may not have the bead 712 at the contact portion 71.

### (Second Modification)

In the above embodiment, there is described the example where the dielectric coating 741, 751 is formed at the periphery of each of the pair of terminal holes 74, 75 of the intermediate plate 70. However, the intermediate plate 70 is not limited to this. In a case where the intermediate plate 70 is made of a dielectric material, or a surface of each of the terminals TN is processed to provide an electric insulation of the terminal N, the dielectric coating 741, 751 may not be formed at the periphery of each of the pair of terminal holes 74, 75, as shown in FIG. 19.

### (Third Modification)

In the above embodiment, there is described the example where the washer 762 is provided to the hole peripheral edge portion 761 of the intermediate plate 70, which is opposed to the first intermediate gear 52. However, the intermediate plate 70 is not limited to this.

As shown in FIG. 20, in place of the washer 762, a lubricating film 763 may be formed at the hole peripheral edge portion 761 of the intermediate plate 70 that forms the sliding surface, along which the first intermediate gear 52 slides. The lubricating film 763 reduces the sliding resistance of the sliding surface, along which the metal gear slides. As the lubricating film 763, for example, a DLC (diamond-like carbon) film or a solid lubricant formed in a film form may be adopted. Therefore, it is possible to limit the wearing of the intermediate plate 70 and the metal gear caused by the sliding between the intermediate plate 70 and the metal gear with the simple structure.

### Other Embodiments

Although the representative embodiment of the present disclosure has been described above, the present disclosure is not limited to the above-described embodiment and can be variously modified as follows, for example.

In the above embodiment, there is exemplified the speed reducer 37 that includes the four gears which include the pinion gear 51, the first intermediate gear 52, the second intermediate gear 53 and the output gear 54. However, the speed reducer 37 is not limited to this. The speed reducer 37 may have, for example, three gears or five or more gears.

In the above embodiments, there is described the case where the metal gears are made of the iron-based sintered metal. However, the present disclosure is not limited to this, and the metal gears may be made of another metal that is other than the iron-based sintered metal. Furthermore, there is exemplified the resin gears made of the fiber-reinforced resin material. However, the present disclosure is not limited to this, and the resin gears may be made of a resin material that does not include the reinforcing fibers.

In the above embodiment, the gears, which are arranged in the transmission path from the pinion gear 51 of the electric motor 36 to the second large diameter portion 62, are the metal gears, and the gears, which are from the second small diameter portion 63 to the output gear 54 on the output side, are the resin gears. However, the speed reducer 37 is not limited to this. For example, the speed reducer 37 may be configured such that one or more of the gears from the pinion gear 51 to the second large diameter portion 62, may be the resin gear(s), and one or more of the gears, which are from the second small diameter portion 63 to the output gear 54 on the output side, may be the metal gear(s).

In the above embodiment, there is exemplified the speed reducer 37 that includes the resin gears while the rotational angle sensor 39 includes the magnetic circuit device 64. However, the gear structure and the structure of the rotational angle sensor 39 are not limited to the above described ones. In the actuator 10, as long as the intermediate plate 70 can limit the scattering of the scattering object from the metal gear to the other space which is other than the space in which the metal gears are located in the internal space 44, the gear structure and the structure of the rotational angle sensor 39 of the speed reducer 37 may be different from those described above.

Specifically, the speed reducer 37 may have another gear structure that does not include the resin gears. In such a case, for example, the intermediate plate 70 is arranged such that the intermediate plate 70 partitions the internal space 44 of the housing 35 into the one space, in which the metal gears are located, and the other space, in which the magnetic circuit device 64 and the sensing device 65 are located.

Furthermore, in the speed reducer 37, the rotational angle sensor 39 may be a sensor other than the magnetic sensor. In such a case, for example, the intermediate plate 70 is arranged such that the intermediate plate 70 partitions the internal space 44 of the housing 35 into the one space, in which the metal gears are located, and the other space, in which the resin gears are located.

In the above embodiment, there is described the example where the intermediate plate 70 seals between the housing main body 41 and the housing case 42. However, the housing 35 is not limited to this. The housing 35 may have, for example, another gasket in addition to the intermediate plate 70. In such a case, the intermediate plate 70 may not be interposed between the housing main body 41 and the housing case 42. Furthermore, the intermediate plate 70 may be configured such that at least a portion of the intermediate plate 70 is shaped in a stepped form or a curved surface form.

In the above embodiment, there is described the example where the washer 762 or the lubricating film 763 is provided to the hole peripheral edge portion 761 of the intermediate plate 70. However, the present disclosure is not limited to this. For example, the washer 762 or the lubricating film 763 may not be provided at the hole peripheral edge portion 761 of the intermediate plate 70.

In the above embodiment, there is exemplified the actuator 10, in which the grease G is applied more to the first metal meshing portion M1 and the second metal meshing portion M2 than the resin meshing portion M3. However, the actuator 10 is not limited to this type. The application locations of the grease G in the actuator 10 may be appropriately set depending on a need.

In the above embodiment, there is described the example where the portion of the rotational angle sensor 39 is formed integrally with the output gear 54. Alternatively, the rotational angle sensor 39 may be formed separately from the output gear 54.

In the above embodiment, the actuator 10 of the present disclosure is applied to the drive device of the boost pressure control valve of the supercharger 24. However, the application of the actuator 10 is not limited to this. The actuator 10 may also be applied to a device for controlling the boost pressure in the supercharger 24, such as a switching device for switching a turbine of a twin-turbo provided with two turbines or a switching device for switching a turbine of a variable capacity turbo. Furthermore, the actuator 10 can be used for other purposes which are other than the controlling of the boost pressure in the supercharger 24

Needless to say, in the above-described embodiments, the elements of each embodiment are not necessarily essential except when it is clearly indicated that they are essential and when they are clearly considered to be essential in principle.

In each of the above embodiments, when a numerical value such as the number, numerical value, amount, range or the like of the constituent elements of the embodiment is mentioned, the present disclosure should not be limited to such a numerical value unless it is clearly stated that it is essential and/or it is required in principle.

In each of the above embodiments, when the shape, positional relationship or the like of the constituent elements of the embodiment is mentioned, the present disclosure should not be limited such a shape or positional relationship unless it is clearly stated that it is essential and/or it is required in principle.

What is claimed is:

1. An actuator comprising:
an electric motor;
an output shaft;
a speed reducer that includes at least one metal gear which has a plurality of teeth made of metal, wherein the speed reducer is configured to transmit rotation, which is outputted from the electric motor, to the output shaft after reducing a rotational speed of the rotation;
a housing that receives the electric motor and the speed reducer; and
a plate member that is configured to limit scattering of a scattering object, which is generated in response to an operation of the speed reducer and is scattered from the at least one metal gear, from one space of an internal space of the housing, in which the at least one metal gear is located, to another space of the internal space of the housing, which is other than the one space, wherein:
the housing includes a first housing portion and a second housing portion;
the first housing portion is joined to the second housing portion in a state where the plate member is placed between the first housing portion and the second housing portion;
the plate member seals between the first housing portion and the second housing portion; and
a seal material is coated to a portion of the plate member which is interposed between the first housing portion and the second housing portion.

2. An actuator comprising:
an electric motor;
an output shaft;
a speed reducer that includes at least one metal gear which has a plurality of teeth made of metal, wherein the speed reducer is configured to transmit rotation, which is outputted from the electric motor, to the output shaft after reducing a rotational speed of the rotation;
a housing that receives the electric motor and the speed reducer; and
a plate member that is configured to limit scattering of a scattering object, which is generated in response to an operation of the speed reducer and is scattered from the at least one metal gear, from one space of an internal space of the housing, in which the at least one metal gear is located, to another space of the internal space of the housing, which is other than the one space, wherein:
the housing includes a first housing portion and a second housing portion;
the first housing portion is joined to the second housing portion in a state where the plate member is placed between the first housing portion and the second housing portion;
the plate member seals between the first housing portion and the second housing portion; and
the plate member has a bead that is squashed when the first housing portion and the second housing portion are joined together.

3. An actuator comprising:
an electric motor;
an output shaft;
a speed reducer that includes at least one metal gear which has a plurality of teeth made of metal, wherein the speed reducer is configured to transmit rotation, which is outputted from the electric motor, to the output shaft after reducing a rotational speed of the rotation;
a rotational angle sensor that includes a magnetic circuit device and a sensing device and is configured to sense a rotational angle of the output shaft; and
a housing that receives the electric motor, the speed reducer and the rotational angle sensor, wherein:
an internal space of the housing is partitioned by a plate member into one space, in which the at least one metal gear is located, and another space, in which the magnetic circuit device and the sensing device are located;
the housing includes a first housing portion and a second housing portion;
the first housing portion is joined to the second housing portion in a state where the plate member is placed between the first housing portion and the second housing portion;
the plate member seals between the first housing portion and the second housing portion; and
a seal material is coated to a portion of the plate member which is interposed between the first housing portion and the second housing portion.

4. An actuator comprising:
an electric motor;
an output shaft;
a speed reducer that includes at least one metal gear which has a plurality of teeth made of metal, wherein the speed reducer is configured to transmit rotation, which is outputted from the electric motor, to the output shaft after reducing a rotational speed of the rotation;
a rotational angle sensor that includes a magnetic circuit device and a sensing device and is configured to sense a rotational angle of the output shaft; and
a housing that receives the electric motor, the speed reducer and the rotational angle sensor, wherein:
an internal space of the housing is partitioned by a plate member into one space, in which the at least one metal gear is located, and another space, in which the magnetic circuit device and the sensing device are located;
the housing includes a first housing portion and a second housing portion;
the first housing portion is joined to the second housing portion in a state where the plate member is placed between the first housing portion and the second housing portion;
the plate member seals between the first housing portion and the second housing portion; and
the plate member has a bead that is squashed when the first housing portion and the second housing portion are joined together.

5. The actuator according to claim 1, wherein the plate member is provided with a sliding member, and the sliding member forms a sliding surface that is placed at a location opposed to the at least one metal gear and is slidable relative to the at least one metal gear.

6. The actuator according to claim 1, wherein:
the plate member has a sliding surface that is placed at a location opposed to the at least one metal gear and is slidable relative to the at least one metal gear; and
a lubricating film, which is configured to reduce a sliding resistance of the sliding surface relative to the at least one metal gear, is formed at the sliding surface.

7. The actuator according to claim 1, wherein:
the plate member has a terminal hole, through which a terminal of the electric motor is inserted; and
a dielectric coating is formed at a periphery of the terminal hole to electrically insulate between the plate member and the terminal.

8. The actuator according to claim 1, wherein the actuator is used as a drive device that is configured to drive a boost pressure control valve of a supercharger.

9. An actuator comprising:
an electric motor;
an output shaft;
a speed reducer that is configured to transmit rotation, which is outputted from the electric motor, to the output shaft after reducing a rotational speed of the rotation; and
a housing that receives the electric motor and the speed reducer, wherein:
the speed reducer includes:
a pair of metal gears, each of which has a plurality of teeth made of metal, wherein the pair of metal gears are meshed with each other;
a resin gear that has a plurality of teeth made of resin; and
a mating gear that is meshed with the plurality of teeth of the resin gear;
grease, which is lubricant, is applied more to a metal meshing portion, at which the pair of metal gears are meshed with each other, than a resin meshing portion, at which the resin gear and the mating gear are meshed with each other; and
an internal space of the housing is partitioned by a plate member into one space, in which the pair of metal gears are located, and another space, in which the resin gear and the mating gear are located.

10. The actuator according to claim 9, comprising a rotational angle sensor, wherein:
the rotational angle sensor includes a magnetic circuit device and a sensing device and is configured to sense a rotational angle of the output shaft; and
the internal space of the housing is partitioned by the plate member into the one space, in which the pair of metal gears are located, and the another space, in which the magnetic circuit device and the sensing device are located.

11. The actuator according to claim 9, wherein:
the housing includes a first housing portion and a second housing portion;
the first housing portion is joined to the second housing portion in a state where the plate member is placed between the first housing portion and the second housing portion; and
the plate member seals between the first housing portion and the second housing portion.

12. The actuator according to claim 11, wherein a seal material is coated to a portion of the plate member which is interposed between the first housing portion and the second housing portion.

13. The actuator according to claim 11, wherein the plate member has a bead that is squashed when the first housing portion and the second housing portion are joined together.
